(19) United States
(12) Patent Application Publication
(10) Pub. No.: US 2012/0269284 A1
(43) Pub. Date: Oct. 25, 2012

(54) Method of Handling Antipodal Parauitary Precoding for MIMO OFDM and Related Communication Device

(76) Inventors: Yu-Chih Jen, Taoyuan County (TW); See-May Phoong, Taipei City (TW); Yuan-Hwui Chung, Taipei City (TW); Hsuan-Jung Su, Taipei City (TW)

(21) Appl. No.: 13/271,258

(22) Filed: Oct. 12, 2011

Related U.S. Application Data
(60) Provisional application No. 61/392,046, filed on Oct. 12, 2010.

(51) Int. Cl. H04L 27/12

(52) U.S. Cl. 375/295

(57) ABSTRACT

A method of transmitting a plurality of data symbols for a transmitter in a wireless communication system is disclosed. The method comprises encoding the plurality of data symbols into a plurality of precoded symbols according to an antipodal paraunitary (APU) precoding; processing the plurality of precoded symbols by using multi-input multi-output (MIMO) and orthogonal frequency-division multiplexing (OFDM), for generating a plurality of transmission symbols; and transmitting the plurality of transmission symbols via a plurality of transmit antennas according to operations of the MIMO and the OFDM.

### CROSS REFERENCE TO RELATED APPLICATIONS

This application claims the benefit of U.S. Provisional Application No. 61/392,046, filed on Oct. 12, 2010 and entitled “Methods and Apparatus for Antipodal Parauitary Precoders for MIMO OFDM systems”, the contents of which are incorporated herein in their entirety.

### BACKGROUND OF THE INVENTION

1. Field of the Invention

The present invention relates to a method used in a wireless communication system and related communication device, and more particularly, to a method of handling antipodal parauitary precoding for MIMO OFDM and related communication device.

2. Description of the Prior Art

A long-term evolution (LTE) system supporting the 3GPP Rel-8 standard and/or the 3GPP Rel-9 standard are developed by the 3rd Generation Partnership Project (3GPP) as a successor of a universal mobile telecommunications system (UMTS), for further enhancing performance of the UMTS to satisfy users' increasing needs. The LTE system includes a new radio interface and radio network architecture that provides a high data rate, low latency, packet optimization, and improved system capacity and coverage. In the LTE system, a radio access network known as an evolved UTRAN (E-UTRAN) includes multiple evolved NBs (eNBs) for communicating with multiple UEs, and communicates with a core network including a mobility management entity (MME), serving gateway, etc. for Non Access Stratum (NAS) control.

A LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint transmission/reception (COMP), UL multiple-input multiple-output (MIMO), etc. For a UE and an eNB to communicate with each other in the LTE-A system, the UE and the eNB must support standards developed for the LTE-A system, such as the 3GPP Rel-10 standard or later versions.

Furthermore, transmit diversity which is a type of the MIMO has been shown to be a cost-effective method for combating channel fading. For realizing the transmit diversity, multiple antennas are needed to be installed at a transmitter, and an amount of antenna installed at a receiver is not limited. Therefore, complexity of the receiver can be reduced (e.g. one antenna at the receiver), while the channel fading is combated by the MIMO. For realizing the transmit diversity, space-time (ST) coding and space-frequency (SF) coding are proposed. For example, the space-time coding with low complexity based on orthogonal codes has drawn a lot of attention. The orthogonal codes can be designed based on an assumption that there are two transmit antennas at the transmitter. The extension to the case where there are more than two transmit antennas are also possible. Advantages of using the orthogonal codes are that channel knowledge is not required at the transmitter, and only simple linear processing is needed at the receiver. On the other hand, combining orthogonal frequency division multiplexing (OFDM), the space-frequency coding with the orthogonal codes can also be used for realizing the transmit diversity. Therefore, not only flat channel fading but also selective channel fading can be combated. Please note that, the space-time coding can also be combined with the OFDM to combat the selective channel fading. Accordingly, when the MIMO is combined with the OFDM, such a combination can be termed MIMO OFDM.

However, even though the channel fading (e.g. flat and selective) can be combated by using the MIMO OFDM, noise (e.g. additive white Gaussian noise (AWGN)) and interference such as inter-cell interference, inter-carrier interference and/or multiuser interference are not mitigated. Further, the noise and the interference may cause extremely low signal-to-noise ratio (SNR) and/or signal-to-noise-plus-interference-ratio (SINR) on at least one subcarrier, and bits transmitted on the at least one subcarrier are difficult to be recovered correctly. Therefore, the extremely low SNR and/or SINR dominate bit error rate (BER). In other words, the extremely low SNR and/or SINR increases the BER a lot, and the BER can not be mitigated by simply using the MIMO OFDM. Therefore, further improvement of the MIMO OFDM is needed.

### SUMMARY OF THE INVENTION

The present invention therefore provides a method and related communication device for handling antipodal parauitary precoding for MIMO OFDM to solve the abovementioned problems.

A method of transmitting a plurality of data symbols for a transmitter in a wireless communication system is disclosed. The method comprises encoding the plurality of data symbols into a plurality of precoded symbols according to an antipodal paraunitary (APU) precoding; processing the plurality of precoded symbols by using multi-input multi-output (MIMO) and orthogonal frequency-division multiplexing (OFDM), for generating a plurality of transmission symbols; and transmitting the plurality of transmission symbols via a plurality of transmit antennas according to the MIMO and the OFDM.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an exemplary wireless communication system according to the present invention.

FIG. 2 is a schematic diagram of an exemplary communication device according to the present invention.

FIG. 3 is a flowchart of an exemplary process according to the present invention.

FIG. 4 is a schematic diagram of a transmitter according to the present invention.

FIG. 5 is a schematic diagram of a transmitter according to the present invention.

FIG. 6 is a table of space-time coded symbols according to the Alamouti encoder shown in FIG. 5.

FIG. 7 is a schematic diagram for illustrating inputs and outputs of the IFFTs of the transmitter shown in FIG. 5.

FIG. 8 is a schematic diagram of a transmitter according to the present invention.

FIG. 9 is a table of space-frequency coded symbols according to the Alamouti encoder shown in FIG. 8.

FIG. 10 is a schematic diagram for illustrating inputs and outputs of the IFFTs of the transmitter shown in FIG. 8.

FIG. 11 is a simulation result of SNRs at all subcarriers observed at an OFDM receiver according to the present invention.

FIG. 12 is a simulation result of BERs according to the present invention.

### DETAILED DESCRIPTION

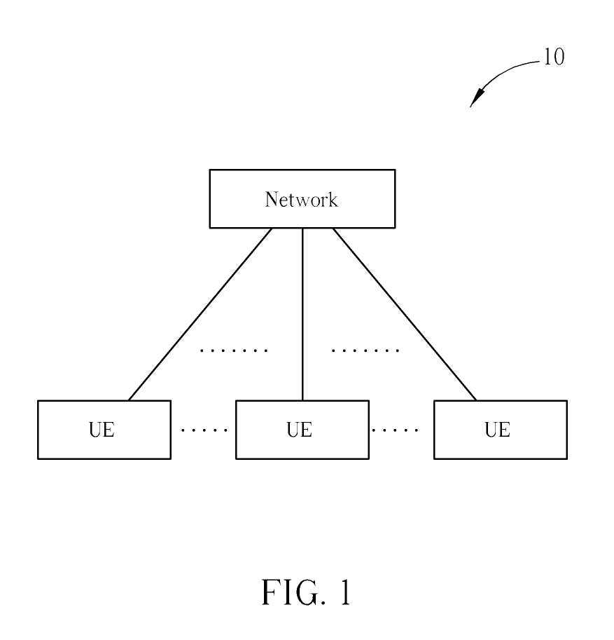

Please refer to FIG. 1, which is a schematic diagram of a wireless communication system 10 according to an example of the present invention. The wireless communication system 10 is briefly composed of a network and a plurality of user equipments (UEs), wherein the network and the UEs support multi-input multi-output (MIMO) and orthogonal frequency-division multiplexing (OFDM). In FIG. 1, the network and the UEs are simply utilized for illustrating the structure of the wireless communication system 10. Practically, the network can be an evolved universal terrestrial radio access network (E-UTRAN) comprising a plurality of evolved Node-Bs (eNBs) and relays in a long term evolution-advanced (LTE-A) system, or an access point (AP) conforming to the IEEE 802.11 standard, and is not limited herein. The UEs can be mobile devices such as mobile phones, laptops, tablet computers, electronic books, and portable computer systems. Besides, the network and a UE can be seen as a transmitter or a receiver according to transmission direction, e.g., for an uplink (UL), the UE is the transmitter and the network is the receiver, and for a downlink (DL), the network is the transmitter and the UE is the receiver.

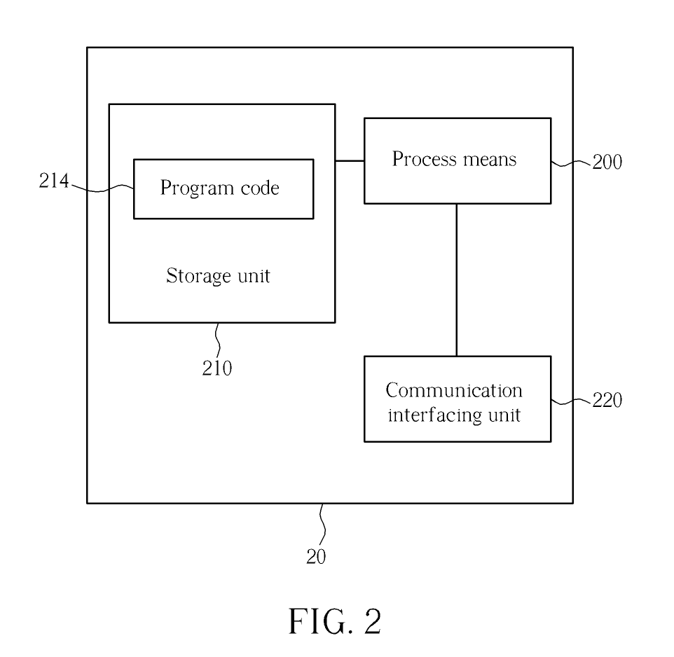

Please refer to FIG. 2, which is a schematic diagram of a communication device 20 according to an example of the present invention. The communication device 20 can be a UE or the network shown in FIG. 1, but is not limited herein. The communication device 20 may include a processor 200 such as a microprocessor or Application Specific Integrated Circuit (ASIC), a storage unit 210 and a communication interfacing unit 220. The storage unit 210 may be any data storage device that can store a program code 214, accessed and executed by the processor 200. Examples of the storage unit 210 include but are not limited to a subscriber identity module (SIM), read-only memory (ROM), flash memory, random-access memory (RAM), CD-ROM/DVD-ROM, magnetic tape, hard disk and optical data storage device. The communication interfacing unit 220 is preferably a transceiver and is used to transmit and receive signals according to processing results of the processor 200.

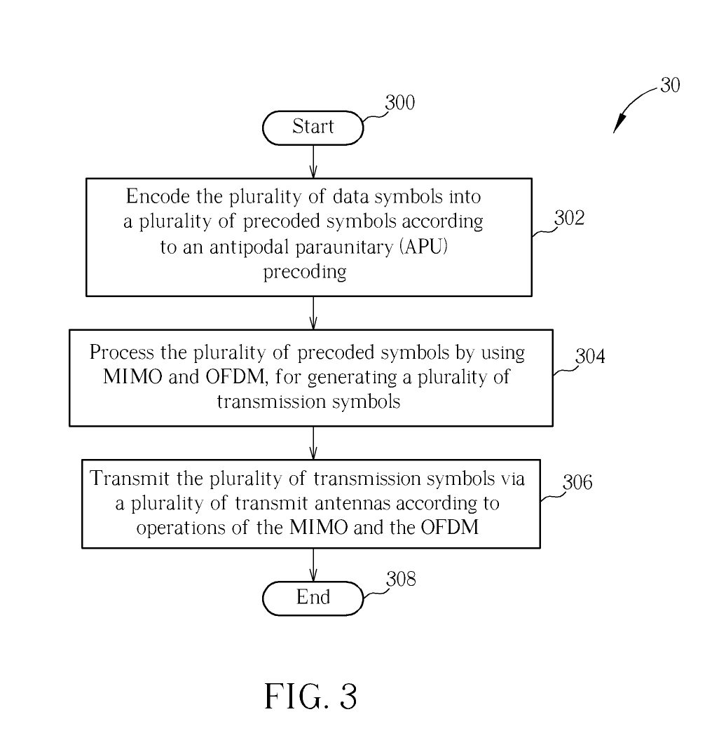

Please refer to FIG. 3, which is a flowchart of a process 30 according to an example of the present invention. The process 30 is utilized in a transmitter of a UE and/or the network shown in FIG. 1, for transmitting a plurality of data symbols. The process 30 may be compiled into the program code 214 and includes the following steps:

Step 300: Start.

Step 302: Encode the plurality of data symbols into a plurality of precoded symbols according to an antipodal paraunitary (APU) precoding.

Step 304: Process the plurality of precoded symbols by using MIMO and OFDM, for generating a plurality of transmission symbols.

Step 306: Transmit the plurality of transmission symbols via a plurality of transmit antennas according to operations of the MIMO and the OFDM.

Step 308: End.

According to the process 30, the transmitter of the UE and/or the network does not transmit the plurality of data symbols directly by using the MIMO and the OFDM, but first encodes the plurality of data symbols into the plurality of precoded symbols according to the APU precoding. Then, the transmitter processes the plurality of precoded symbols by using the MIMO and the OFDM, for generating the plurality of transmission symbols, and transmits the plurality of transmission symbols via the plurality of transmit antennas according to operations of the MIMO and the OFDM. Since the plurality of data symbols are precoded before being transmitted, signal-to-noise ratios (SNRs) and/or signal-to-noise-plus-interference-ratios (SINRs) at subcarriers at the receiver are averaged by the APU precoding and become flat. In other words, the SNRs and/or SINRs are controlled to be at a similar level, such that extremely low SNRs and/or SINRs hardly happen at a subcarrier and bits transmitted on the subcarrier are hardly correctly recovered.

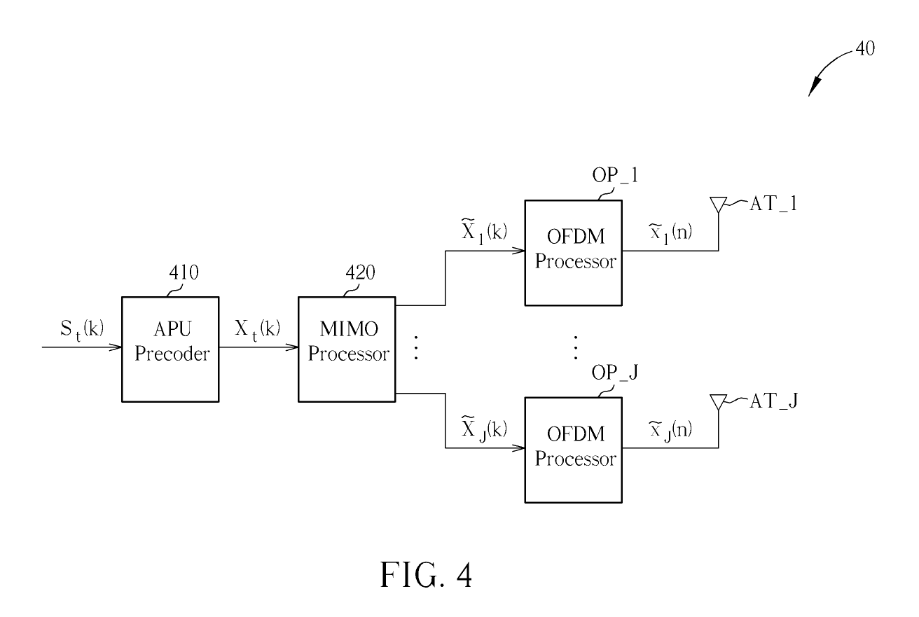

In detail, please refer to FIG. 4, which is a schematic diagram of a transmitter 40 according to an example of the present invention. The transmitter is used for realizing the process 30, and includes an APU precoder 410, a MIMO processor 420, multiple OFDM processors OP_1-OP_J and multiple transmit antennas AT_1-AT_J. In FIG. 4, a plurality of data symbols Sₜ(k), 0≦k≦M−1, are precoded by the APU precoder 410, for generating the plurality of precoded symbols Xₜ(k), 0≦k≦M−1, wherein k, t and M are integers, M≧1 and t is a time index. t is used for identifying a sequence of the plurality of data symbols Sₜ(k) in the time domain, and be also defined as an index of a transport block used in the LTE-A system, and is not limited herein. Realization of the APU precoder 410 is not limited. For example, the APU precoder 410 can be realized by using an APU polynomial matrix, which is formulated as follows:

$$T ( z ) = {\sum }_{r = 0}^{P} {T}_{r} {z}^{- r} ; \qquad ( Eq . 1 )$$

wherein T(z)T(z)^{H}=I and I is an identity matrix with a dimension M×M, i.e., T(z) is a paraunitary matrix with the dimension M×M. (•)^{H} denotes conjugate transpose operation. Further, Tᵣ, 0≦r≦P are matrices with the dimension M×M of which all entries are of the same magnitude (e.g. +1 or −1), wherein r is an integer. P is an order of the APU polynomial matrix T(z). Therefore, T(z) is the APU polynomial matrix, and only additions are required to realize T(z) and multiplications are not needed. Complexity for realizing T(z) is low. Further, Xₜ(k) can be obtained from Sₜ (k) via the following equation:

$${X}_{t} = {\sum }_{r = 0}^{P} {T}_{r} {S}_{t - r} ; \qquad ( Eq . 2 )$$

wherein Xₜ=[Xₜ(0), . . . , Xₜ(M−1)]^{T} and Sₜ=[Sₜ(0), . . . , Sₜ(M−1)]^{T}. In other words, Xₜ(k) are obtained by convolving Sₜ(k) and T(z).

Then, Xₜ(k) are processed by the MIMO processors 420, and J groups of symbols X₁(k)-X_{J}(k) are generated according to a space-time (ST) coding or a space-frequency (SF) coding. Besides, the MIMO processors 420 also arrange J groups of symbols \tilde{X}₁(k)-\tilde{X}_{J}(k) to OFDM processors OP_1-OP_J, respectively. The OFDM processors OP_-OP_J process the J groups of symbols \tilde{X}₁(k)-\tilde{X}_{J}(k), respectively, and correspondingly generate J groups of transmission symbols \tilde{x}₁(n)-\tilde{x}_{J}(n). Then, the J groups of transmission symbols \tilde{x}₁(n)-\tilde{x}_{J}(n) are transmitted via the transmit antennas AT_1-AT_J, respectively. Therefore, via the APU precoder 410, transmitter 40 can mitigate noise (e.g. additive white Gaussian noise (AWGN)) and interference such as inter-cell interference, inter-carrier interference and/or multiuser interference such that SNRs and/or SINRs at the subcarriers at the receiver are averaged and become flat. Bit error rate (BER) of the plurality of data symbols Sₜ(k) will not be severely affected by the abovementioned negative effects.

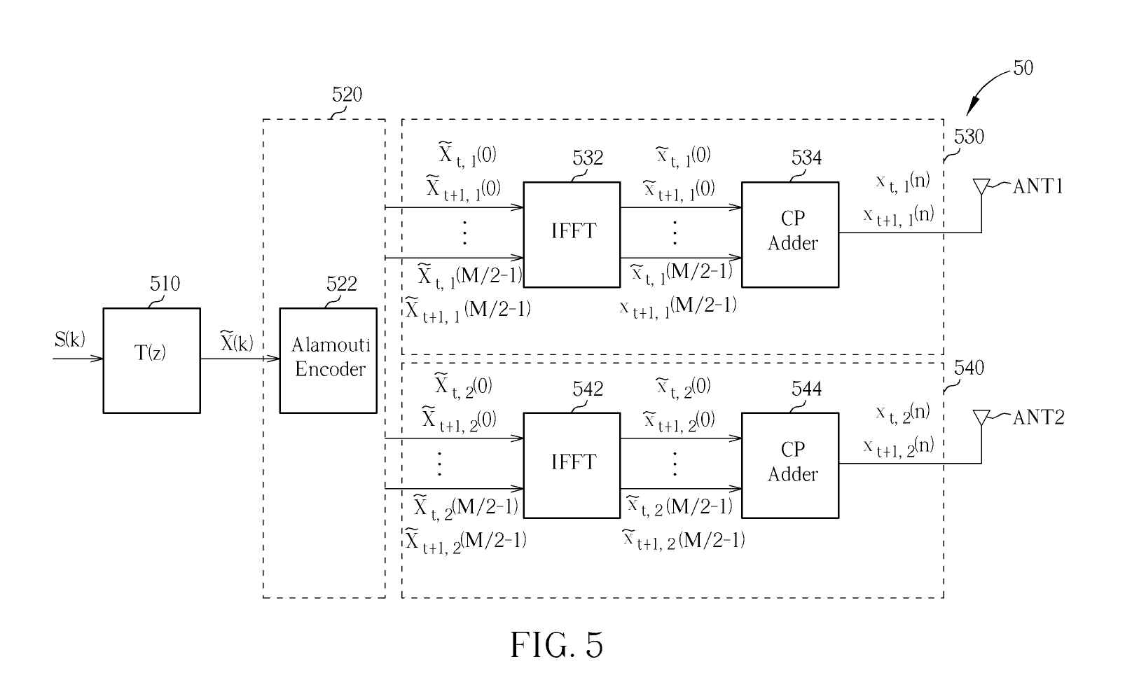

Please refer to FIG. 5, which is a schematic diagram of a transmitter 50 according to an example of the present invention. The transmitter 50 is used for clearly illustrating the transmitter 40 by simply using a space-time coding and two transmit antennas. The transmitter 50 includes an APU precoder 510, a MIMO processor 520, OFDM processors 530 and 540, and transmit antennas ANT1 and ANT2. Further, the MIMO processor 520 includes an Alamouti encoder 522 for performing the space-time coding. The OFDM processor 530 includes an inverse fast Fourier transform (IFFT) 532 and a cyclic prefix (CP) adder 534. Similarly, The OFDM processor 540 includes an IFFT 542 and a CP adder 544.

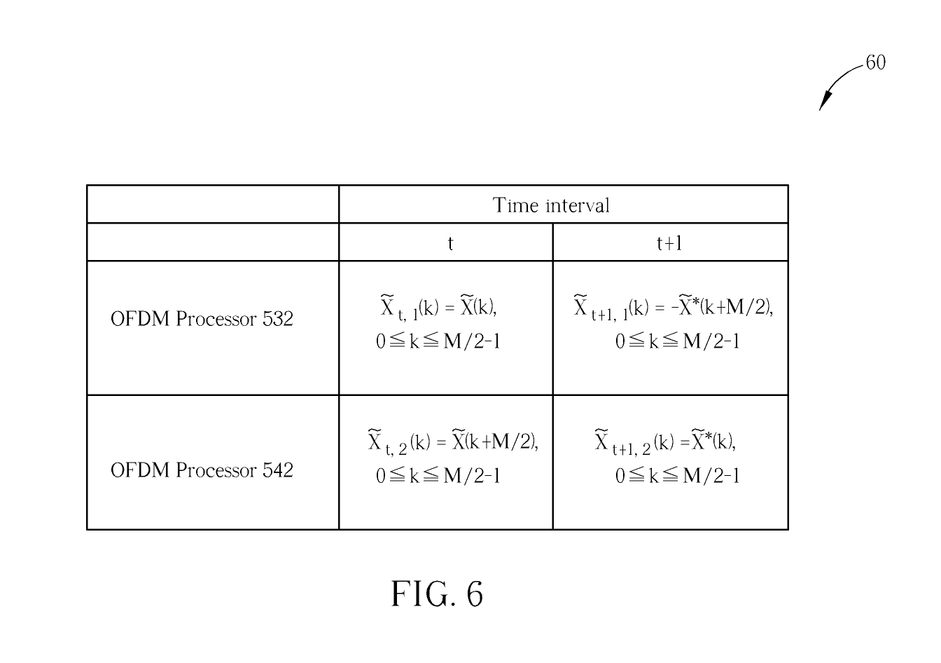

Operation of the transmitter 50 is explained as follows. Data symbols S(k), 0≦k≦M−1 are first precoded by the APU precoder 510 according to the equations Eq. 1 and Eq. 2 to generate precoded symbols \tilde{X}(k), 0≦k≦M−1. Then, the precoded symbols \tilde{X}(k) are coded by the Alamouti encoder 522, and space-time coded symbols \tilde{X}_{t,1}(k), \tilde{X}_{t,2}(k), \tilde{X}_{t+1,1}(k) and \tilde{X}_{t+1,2}(k), 0≦k≦M/2−1 are correspondingly generated for the OFDM processors 530 and 540. More specifically, the space-time coded symbols \tilde{X}_{t,1}(k) and \tilde{X}_{t+1,1}(k) are processed by the OFDM processor 530, and corresponding processed results x_{t,1}(n) and x_{t+1,1}(n) are transmitted via the transmit antenna ANT1 in successive time intervals t and t+1, respectively. Similarly, the space-time coded symbols \tilde{X}_{t,2}(k) and \tilde{X}_{t+1,2}(k) are processed by the OFDM processor 540, and corresponding processed results x_{t,2}(1) and x_{t+1,2}(n) are transmitted via the transmit antenna ANT2 in the successive time intervals t and t+1, respectively. Relations between the precoded symbols and the space-time coded symbols which are established by the Alamouti encoder 522 are shown in the table 60 of FIG. 6, wherein (•)* denotes conjugate operation.

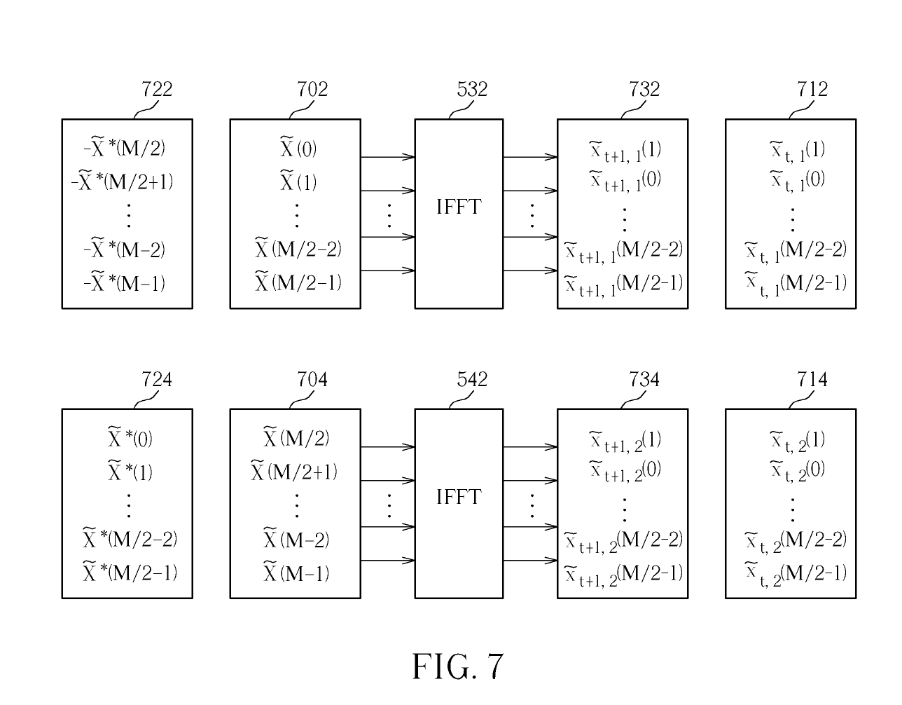

Furthermore, please refer to FIG. 7, which is a schematic diagram for illustrating operations of the IFFTs 532 and 542 according to the table 60. According to FIG. 7, space-time coded blocks 702 (i.e., \tilde{X}_{t,1}(k)) and 722 (i.e., \tilde{X}_{t+1,1}(k)) are transformed by the IFFT 532 into symbol blocks 712 (i.e., \tilde{x}_{t,1}(n)) and 732 (i.e., \tilde{x}_{t+1,1}(n)), respectively. Symbols of the symbol blocks 712 and 732 are then passed to the CP adder 534, and OFDM symbols composed of x_{t,1}(n) and x_{t+1,1}(n) are formed and are transmitted successively via the transmit antenna ANT1 in the successive time intervals t and t+1, respectively. Similarly, space-time coded blocks 704 (i.e., \tilde{X}_{t,2}(k)) and 724 (i.e., \tilde{X}_{t+1,2}(k)) are transformed by the IFFT 542 into symbol blocks 714 (i.e., \tilde{x}_{t,2}(n)) and 734 (i.e., \tilde{x}_{t+1,2}(n)), respectively. Symbols of the symbol blocks 714 and 734 are then passed to the CP adder 544, and OFDM symbols composed of x_{t,2}(n) and xₜ₊1,2(n) are formed and are transmitted successively via the transmit antenna ANT2 in the successive time intervals t and t+1, respectively.

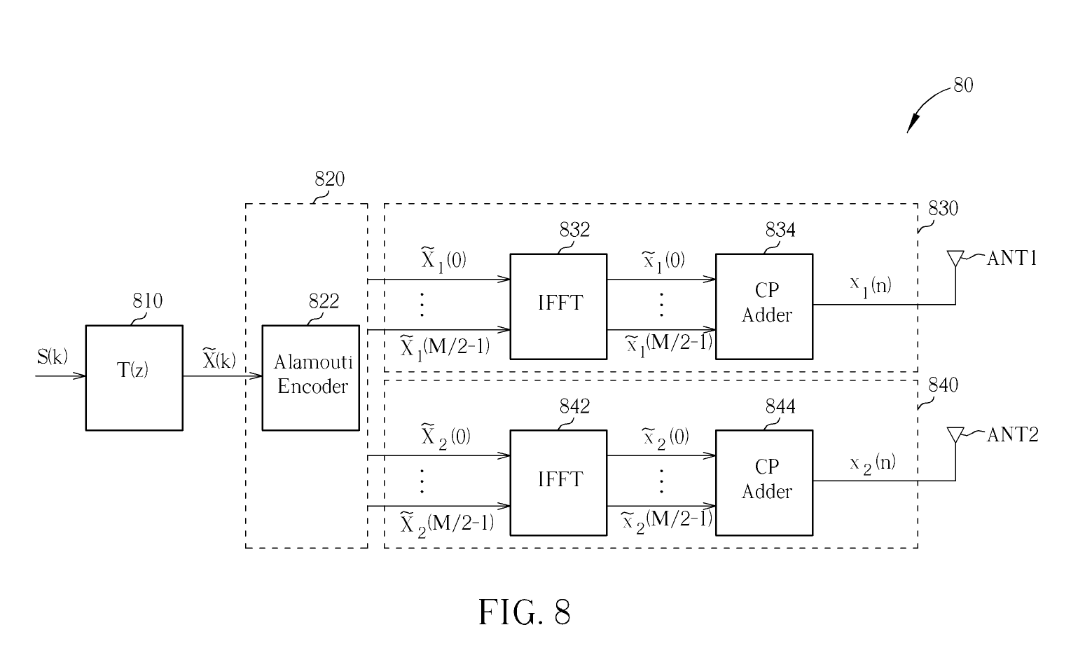

On the other hand, please refer to FIG. 8, which is a schematic diagram of a transmitter 80 according to an example of the present invention. The transmitter 80 is used for clearly illustrating the transmitter 40 by simply using a space-frequency coding and two transmit antennas. The transmitter 80 includes an APU precoder 810, a MIMO processor 820, OFDM processors 830 and 840, and transmit antennas ANT1 and ANT2. Further, the MIMO processor 820 includes an Alamouti encoder 822 for performing the space-frequency coding. The OFDM processor 830 includes an IFFT 832 and a CP adder 834. Similarly, The OFDM processor 840 includes an IFFT 842 and a CP adder 844.

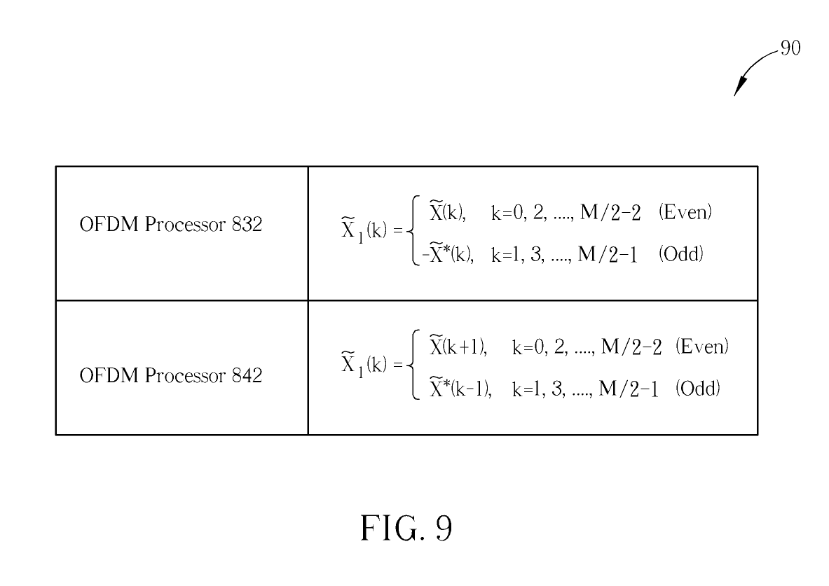

Operation of the transmitter 80 is explained as follows. Data symbols S(k), 0≦k≦M−1 are first precoded by the APU precoder 810 according to the equations Eq. 1 and Eq. 2 to generate precoded symbols \tilde{X}(k), 0≦k≦M−1. Then, the precoded symbols \tilde{X}(k) are coded by the Alamouti encoder 822, and space-frequency coded symbols \tilde{X}₁(k) and \tilde{X}₂(k), 0≦k≦M/2−1 are respectively generated for the OFDM processors 830 and 840. More specifically, the space-frequency coded symbols \tilde{X}₁(k) are processed by the OFDM processor 830 and corresponding processed results x₁(n) are transmitted via the transmit antenna ANT1. Similarly, the space-frequency coded symbols \tilde{X}₂(k) are processed by the OFDM processor 840, and corresponding processed results x₂(n) are transmitted via the transmit antenna ANT2. Relations between the precoded symbols and the space-frequency coded symbols which are established by the Alamouti encoder 822 are shown in the table 90 of FIG. 9.

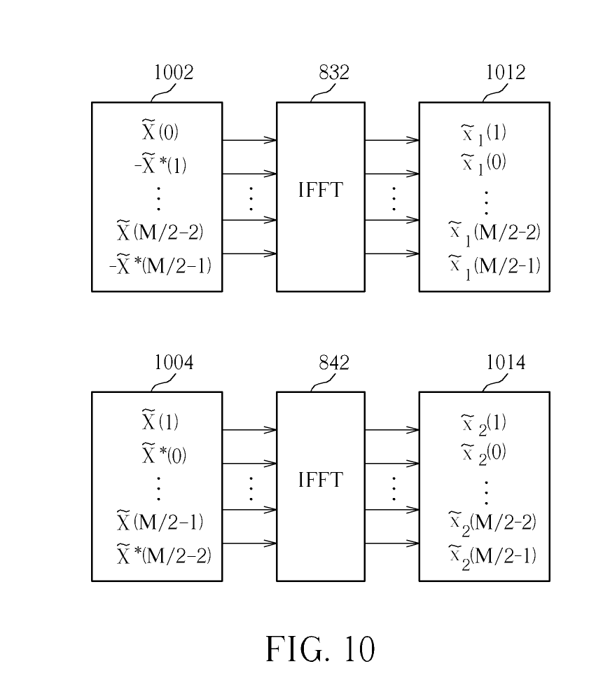

Furthermore, please refer to FIG. 10, which is a schematic diagram for illustrating operations of the IFFTs 832 and 842 according to the table 90. According to FIG. 10, a space-frequency coded block 1002 (i.e., \tilde{X}₁(k)) is transformed by the IFFT 832 into a symbol block 1012 (i.e., \tilde{x}₁(n)). Symbols of the symbol block 1012 are then passed to the CP adder 834, and an OFDM symbol composed of x₁(n) is formed and is transmitted via the transmit antenna ANT1. Similarly, a space-frequency coded block 1004 (i.e., \tilde{X}₂(k)) is transformed by the IFFT 842 into a symbol block 1014 (i.e., \tilde{x}₂(n)). Symbols of the symbol block 1014 are then passed to the CP adder 844, and an OFDM symbol composed of x₂(n) is formed and is transmitted via the transmit antenna ANT2.

Please note that, parameter M used in the space-time coding and the space-frequency coding is preferably a number equal to powers of 2. For example, a possible value of M can be 256, 512, 1024, etc, and is not limited herein. In this situation, the APU precoder and the IFFT can be realized in a butterfly structure, and only low complexity is needed. Further, since complexity of the APU precoder is affected by the order of the APU polynomial matrix P, i.e., the complexity increases with P. On the other hand, performance of the APU precoder also increases with P. Considering the complexity and the performance, P is preferable set to 0, 2, 4, 6, etc. Besides, due to that an amount of the data symbols S(k) (i.e., M) is twice a size of the IFFT (i.e., M/2) and property of the space-time coding, two time intervals are needed for transmitting space-time coded symbols. In other words, information of the data symbols S(k) is distributed in x_{t,1}(n), x_{t+1,1}(n), x_{t,2}(n) and x_{t+1,2}(n). On the other hand, for the space-frequency coding, half of the data symbols S(k) are first space-frequency coded. Therefore, only information of the half of the data symbols S(k) is distributed in x₁(n) and x₂(n) in the first transmission. Then, the rest data symbols S(k) are space-frequency coded, and are transmitted in x₁(n) and x₂(n) in the next transmission.

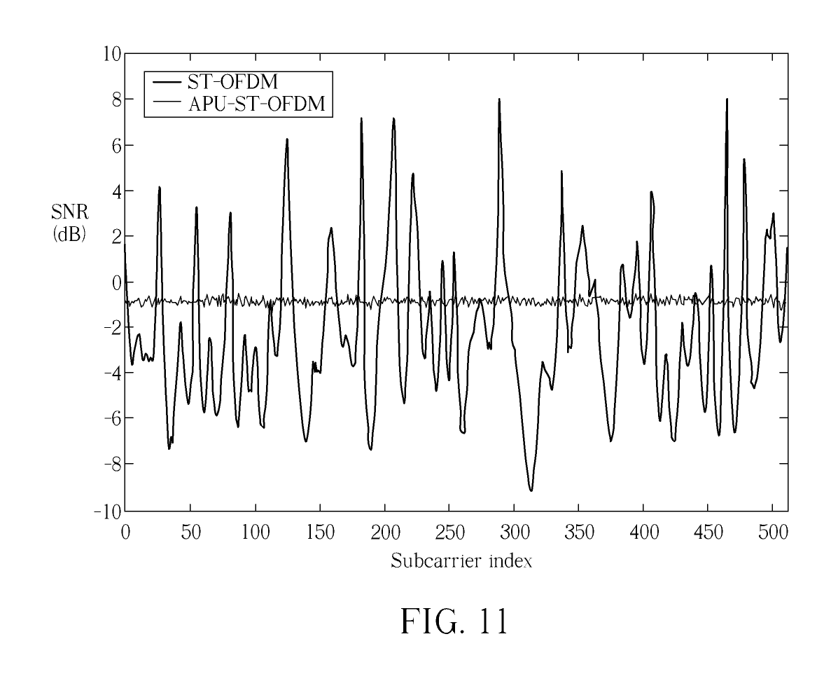

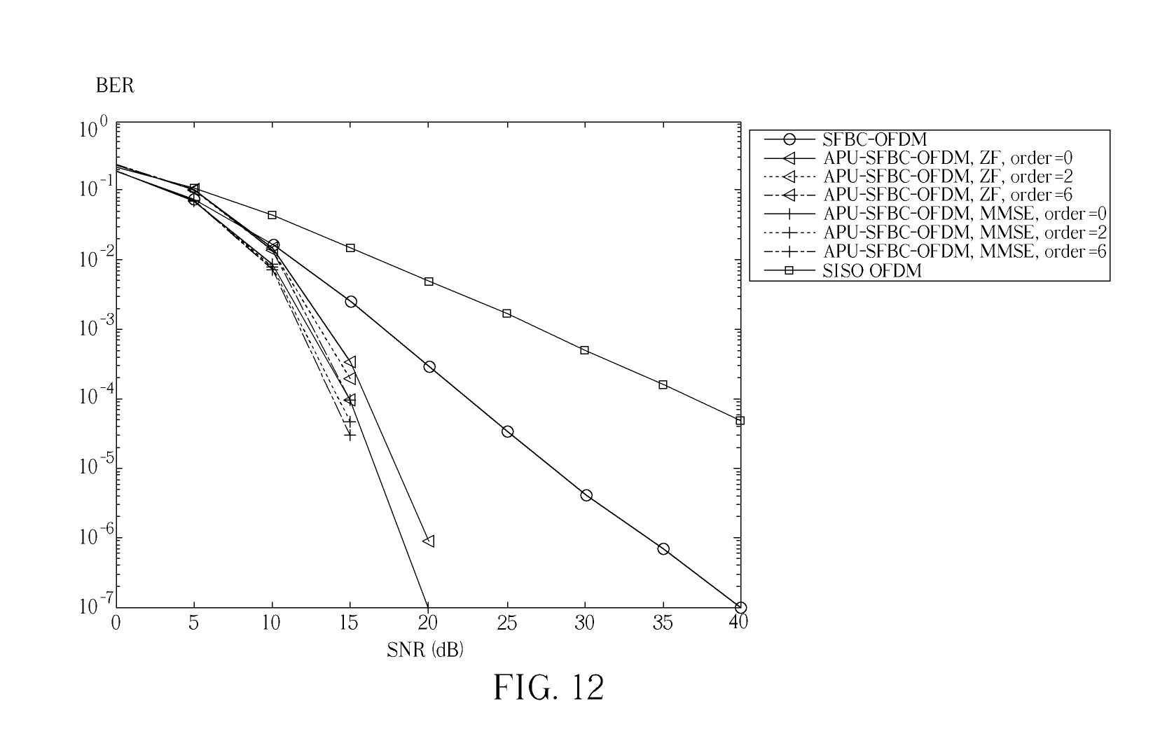

Please refer to FIG. 11, which is a simulation result of an OFDM transmitter using a space-time coding, wherein a size of the IFFT is 512 (i.e., M/2=512). SNRs at all subcarriers observed at the OFDM receiver with and without using the APU precoding are compared in the simulation result. As shown in FIG. 11, when the APU precoding is not used, SNRs at different subcarriers differ a lot and extremely low SNRs appear due to randomness of noise. Oppositely, when the APU precoding is used, SNRs at all subcarriers are controlled to be at a similar level and extremely low SNRs do not appear. Furthermore, please refer to FIG. 12, wherein a simulation result of BERs is used to demonstrate impact of improving SNRs, and SISO represents single-input single-output without using the APU precoding. Data symbols are first modulated by using quadrature phase-shift keying (QPSK) and precoded. Then, precoded symbols are space-frequency coded and transmitted in a 4-path multipath channel with AWGN. As shown in FIG. 12, whether a zero-forcing (ZF) receiver or a minimum mean square error (MMSE) receiver is used, BERs are much better when the APU precoding is used. Further, the BERs are improved a lot even if order of the APU polynomial matrix P is small, e.g., 2 or 6. In other words, the BERs are improved by using the APU precoding without requiring large complexity. Therefore, the present invention improves SNRs observed at the OFDM receiver, and the BERs can be reduced accordingly.

Please note that, the abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

In conclusion, noise (e.g. AWGN) and interference such as inter-cell interference, inter-carrier interference and/or multiuser interference can be mitigated by using the APU precoding such that SNRs and/or SINRs at the subcarriers at the receiver are averaged and become flat. Therefore, BER of data symbols will not be affected by extremely low SNR and/or SINRs caused by the abovementioned negative effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of transmitting a plurality of data symbols for a transmitter in a wireless communication system, the method comprising:
encoding the plurality of data symbols into a plurality of precoded symbols according to an antipodal paraunitary (APU) precoding;
processing the plurality of precoded symbols by using multi-input multi-output (MIMO) and orthogonal frequency-division multiplexing (OFDM), for generating a plurality of transmission symbols; and
transmitting the plurality of transmission symbols via a plurality of transmit antennas according to operations of the MIMO and the OFDM.

2. The method of claim 1, wherein encoding the plurality of data symbols into the plurality of precoded symbols according to the APU precoding comprises:
using an APU polynomial matrix,
$$T ( z ) = {\sum }_{r = 0}^{P} {T}_{r} {z}^{- r} ,$$
for encoding the plurality of data symbols into the plurality of precoded symbols;
wherein the APU polynomial matrix T(z) is a paraunitary matrix with a dimension M×M, and Tᵣ, 0≦r≦P are matrices with the dimension M×M of which all entries are of the same magnitude, wherein r is an integer, and P is an order of the APU polynomial matrix T(z).

3. The method of claim 2, wherein using the APU polynomial matrix for encoding the plurality of data symbols into the plurality of precoded symbols comprises:
convolving the APU polynomial matrix with the plurality of data symbols to obtain the plurality of precoded symbols.

4. The method of claim 1, wherein the MIMO comprises a space-time coding.

5. The method of claim 4, wherein processing the plurality of precoded symbols by using the MIMO and the OFDM, for generating the plurality of transmission symbols comprises:
encoding the plurality of precoded symbols into a plurality of space-time coded symbols by using the space-time coding;
arranging the plurality of space-time coded symbols in a plurality of OFDM symbols in time domain according to the operations of the MIMO and the OFDM; and
transforming the plurality of OFDM symbols into the plurality of transmission symbols by using the OFDM.

6. The method of claim 5, wherein the space-time coding is an Alamouti coding, and the plurality of OFDM symbols are consecutive in the time domain.

7. The method of claim 1, wherein the MIMO comprises a space-frequency coding.

8. The method of claim 7, wherein processing the plurality of precoded symbols by using the MIMO and the OFDM, for generating the plurality of transmission symbols comprises:
encoding the plurality of precoded symbols into a plurality of space-frequency coded symbols by using the space-frequency coding;
arranging the plurality of space-frequency coded symbols in a plurality of OFDM subcarriers in frequency domain according to the MIMO and the OFDM; and
transforming the plurality of OFDM subcarriers into the plurality of transmission symbols by using the OFDM.

9. The method of claim 8, wherein the space-frequency coding is an Alamouti coding, and the plurality of OFDM subcarriers are consecutive in the frequency domain.
